(19) United States
(12) Patent Application Publication
(10) Pub. No.: US 2017/0053347 A1
(43) Pub. Date: Feb. 23, 2017

(54) SYSTEMS AND METHODS FOR AUTOMATIC GENERATION OF A DYNAMIC TRANSACTION STANDING IN A NETWORK ENVIRONMENT

(71) Applicant: Behalf Ltd., RaAnana (IL)

(72) Inventors: Lior LIPSHITZ, Zikhron-Yaakov (IL); Ziv SHABAT, Rehovot (IL); Russell Mark WEISS, ModiIn Ilit (IL)

(21) Appl. No.: 15/238,931

(22) Filed: Aug. 17, 2016

Related U.S. Application Data
(60) Provisional application No. 62/205,752, filed on Aug. 17, 2015.

(51) Int. Cl. G06Q 40/02; G06Q 30/06

(52) U.S. Cl. CPC G06Q 40/025; G06Q 30/0601

(57) ABSTRACT

There is provided a method for analyzing data collected from network nodes, the method executed by a server connected to at least one website and at least one consumer node, comprising: identifying a transaction request at a website hosted by a web server, the transaction requested by an entity associated with a consumer node; identifying at least one key person associated with the entity; collecting, from a plurality of network nodes, metadata associated with the at least one key person; analyzing the metadata to create at least one characteristic of the at least one key person; generating a dynamic transaction standing based on the at least one characteristic; determining whether the dynamic transaction standing satisfies a transaction requirement associated with the transaction request; and transmitting, to a node associated with the at least one key person, at least one offer when the dynamic transaction standing satisfies the transaction requirement.

### RELATED APPLICATION

This application claims the benefit of priority under 35 USC §119(e) of U.S. Provisional Patent Application No. 62/205,752 filed on Aug. 17, 2015, the contents of which are incorporated herein by reference in their entirety.

### FIELD AND BACKGROUND OF THE INVENTION

The present invention, in some embodiments thereof, relates to systems and methods for analysis of data distributed at multiple network nodes and, more specifically, but not exclusively, to systems and methods for automatic generation of a dynamic transaction standing based on data collected from multiple network nodes.

When a customer wishes to buy an item from a supplier and requires financing, the customer often requests terms of repayment from the supplier. The supplier may decline to provide the customer a line of credit if the customer is either unknown to the supplier or the risk of the customer not repaying the supplier is perceived as too great.

The customer will then usually contact his or her lending institution to apply for a monetary loan. After checking the customer's business information and business credit standing, as well as their personal information and credit history, a representative of the lending institution informs the customer of the loan amount, period, and interest rate for which he or she is eligible. If the customer agrees to the terms of the loan, the representative of the lending institution delivers documentation to the customer that, when executed, grants the lending institution a security interest in the purchased product for the monetary loan.

The ways in which people purchase goods has significantly progressed since the development of the worldwide web (WWW). Customers may now shop from the convenience of their home, office, or while on the road using portable devices.

With the advantages of electronic commerce (e-commerce), many aspects of the above process for obtaining financing for purchases may now be performed online. However, while these and other online options are often much more convenient than their manual counterparts, they still require time and effort from the customer, and require the customer to provide sufficient securities to the lending institution before financing may be secured. Such solutions therefore cause inconvenience to the user, delaying the user's purchase and discouraging further purchases. Such solutions may additionally increase the computing resources needed to complete a transaction by requiring additional displays to the user and/or inputs from the user before financing may be secured.

### SUMMARY OF THE INVENTION

According to an aspect of some embodiments of the present invention there is provided a computer implemented method for analyzing data collected from a plurality of network nodes, the method executed by a server connected to at least one website and at least one consumer node, the method comprising: identifying a transaction request at a website hosted by a web server, the transaction requested by an entity associated with a consumer node; identifying at least one key person associated with the entity; collecting, from a plurality of network nodes, metadata associated with the at least one key person; analyzing the metadata to create at least one characteristic of the at least one key person; generating a dynamic transaction standing based on the at least one characteristic; determining whether the dynamic transaction standing satisfies a transaction requirement associated with the transaction request; and transmitting, to a node associated with the at least one key person, at least one offer when the dynamic transaction standing satisfies the transaction requirement.

Optionally, the transaction request comprises a financial purchase transaction to purchase at least one product and/or service from the website by the entity, wherein the entity comprises a business entity, wherein the dynamic transaction standing comprises a dynamic credit standing, wherein the transaction requirement comprises a credit standing requirement, and wherein the at least one offer comprises at least one financial offer to provide financing to complete the financial purchase transaction.

Alternatively or additionally, the transaction request comprises a request to access the website by the entity, wherein the entity comprises a non-profit and/or environmental and/or charity associated entity, wherein the dynamic transaction standing comprises a dynamic public perception standing indicative of the perception of the public on the entity, wherein the transaction requirement comprises a public perception requirement, and wherein the at least one offer comprises help to improve public perception to access the website.

Optionally, the at least one offer is calculated according to the difference between the dynamic transaction standing and the transaction requirement associated with the transaction request, wherein the difference is indicative of the amount of financial credit required to complete the transaction.

Optionally, the identifying at least one key person associated with the entity is automatically performed by the server, the identifying comprises: generating a graph based on the metadata collected from each of the plurality of network nodes, wherein connections are defined between nodes of the graph each storing metadata collected from a respective network node, wherein the connections denote similarity and/or relationships between instances of the metadata; and analyzing the graph to identify the at least one key person according to the entity.

Optionally, at least one weight is assigned to each connection according to the type and/or accuracy of overlapping fields.

Optionally, the method further comprises analyzing the graph to identify duplicate data, wherein the duplicate data is associated with a higher probability of accuracy relative to non-duplicated data, wherein the duplicate data is assigned a relatively higher weight to identify the at least one key person relative to non-duplicate data.

Optionally, the method further comprises analyzing the graph to resolve inconsistencies in the data.

Optionally, the method further comprises analyzing the graph to correct errors in the data.

Optionally, the method further comprises analyzing the graph to complete missing details in the data.

Optionally, the collecting, from the plurality of network nodes, metadata associated with the at least one key person, comprises collecting, using crawling software that crawls the network, data from websites posting data about the at least one key person. Optionally, the websites are selected from the group consisting of: social network sites, blog sites, review sites, and news sites.

Optionally, the collecting is performed by tracking activity of users of the entity accessing websites using the customer node.

According to an aspect of some embodiments of the present invention there is provided a system for analyzing data collected from a plurality of network nodes, comprise: a server comprising: a network interface that provides communication with at least one website hosted by at least one web server, at least one consumer node, and a plurality of network nodes storing data; a program store storing code; and at least one processor coupled to the network interface and the program store for implementing the stored code, the code comprising: code to identify a transaction request at the transaction requested by an entity associated with a consumer node, identify at least one key person associated with the entity, collect from a plurality of network nodes, metadata associated with the at least one key person, code to analyzing the metadata to create at least one characteristic of the at least one key person, generate a dynamic transaction standing based on the at least one characteristic, determine whether the dynamic transaction standing satisfies a transaction requirement associated with the transaction request; and code to transmit, to a client terminal associated with the at least one key person, at least one offer when the dynamic transaction standing satisfies the transaction requirement.

According to an aspect of some embodiments of the present invention there is provided a computer program product comprising a non-transitory computer readable storage medium storing program code thereon for implementation by at least one processor of a server connected to at least one website and at least one consumer node, for analyzing data collected from a plurality of network nodes, comprising: instructions to identify a transaction request at a website hosted by a web server, the transaction requested by an entity associated with a consumer node; instructions to identify at least one key person associated with the entity; instructions to collect, from a plurality of network nodes, metadata associated with the at least one key person; instructions to analyze the metadata to create at least one characteristic of the at least one key person; instructions to generate a dynamic transaction standing based on the at least one characteristic; instructions to determine whether the dynamic transaction standing satisfies a transaction requirement associated with the transaction request; and instructions to transmit, to a node associated with the at least one key person, at least one offer when the dynamic transaction standing satisfies the transaction requirement.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for analyzing data collected from network nodes, to identify one or more key person(s) associated with an entity requesting a transaction at a web server, and/or to analyze metadata collected from multiple network sources to generate an offer to the key person to assist with the transaction request, in accordance with some embodiments of the present invention;

FIG. 2 is a block diagram of a system that analyses metadata collected from network sources to generate an offer to an identified key person to assist with a transaction request at a web server, in accordance with some embodiments of the present invention;

FIGS. 3A-3C include an example of a graph that includes connections between metadata sources shown at various levels of zoom-in, in accordance with some embodiments of the present invention;

FIG. 4 is a schematic diagram of another network system, in accordance with some embodiments of the present invention;

FIG. 5 is a flowchart of a method for offering and enabling web-based purchase financing, in accordance with some embodiments of the present invention;

FIG. 6 is a flowchart of a method for identifying a key person associated with an entity, in accordance with some embodiments of the present invention; and

FIG. 7 is another flowchart a method for proactively offering financing offers to business entities, in accordance with some embodiments of the present invention.

### DESCRIPTION OF SPECIFIC EMBODIMENTS OF THE INVENTION

The present invention, in some embodiments thereof, relates to systems and methods for analysis of data distributed at multiple network nodes and, more specifically, but not exclusively, to systems and methods for automatic generation of a dynamic transaction standing based on data collected from multiple network nodes.

An aspect of some embodiments of the present invention relates to systems and/or methods (e.g., implemented by code instructions executed by one or more processors) that collected and analyze data dynamically from multiple network nodes to generate an offer to a key person(s) of an entity requesting a transaction at a website according to a transaction requirement. The transaction is requested by an entity using a consumer node, at website site hosted by a web server. The key person associated with the entity is identified, optionally automatically, based on data collected from multiple nodes. Metadata associated with the key person is collected from multiple nodes, and analyzed to create one or more characteristics for the key person. A dynamic transaction standing is generated based on the characteristics. When the dynamic transaction standing satisfies the transaction requirement associated with the transaction request, an offer(s) to assist with the transaction is transmitted to the network node used by the key person.

The transaction request may be associated with a financial transaction to purchase products and/or services from the website by the entity. The entity may be a business entity, for example, a private company, a publicly traded company. The key person may be, for example, the chief executive officer (CEO), the chief financial officer (CFO), the owner, a member of the board of directors, or other person having significant influence within the company. The dynamic transaction standing may include a dynamic credit standing, indicating the ability of the entity to borrow money. The transaction requirement may include a requirement or range for which the web site will allow the entity have the required credit standing to complete the financial transaction. The offer may include a financial offer, for example, an offer to lend additional funds to complete the financial transaction, and/or an offer to provide the product(s) and/or service(s) on credit.

The transaction request may be associated with a request to perform a non-financial activity, for example, to organize a protest, to organize an event in a city, and/or to access the website to obtain information (e.g., group forum requiring an invitation). The entity may be a non-business entity, for example, a non-profit, an academic institution, a public (e.g., government) institution, a charity, and/or an environmental institution. The dynamic transaction standing may include, for example, a public perception standing of the entity, and a history of mischief by the entity. The offer may include an offer to improve the public perception and/or improve good behavior by the entity.

Optionally, the key person is automatically identified. The key person may be automatically identified by generating a graph using metadata collected from multiple network nodes and/or databases and/or other sources. Connections (i.e., edges) are defined between the data sources (i.e., stored in graph vertices). The graph may be analyzed using graph analysis methods to identify similarities in the data, and/or links in the data, for identifying the most important key person(s) in the organization. The graph may be analyzed using graph analysis methods to perform one or more of: reducing overlapping data, correct errors in the data, resolve inconsistencies, and/or fill-in in complete details.

The systems and/or methods described herein improve an underlying technical process within the technical field of online transactions at web sites hosted by web servers accessed by consumer nodes. The systems and/or methods described herein relate to the technical problem of identifying when a transaction may be completed, and/or identifying the key person responsible for the entity requesting the transaction, and and/or providing an offer to the key person to assist with completion of the transaction.

The systems and/or methods described herein improve performance of the server executing the analysis code. The improvement in performance is obtained by reducing the processing time, processing resources, and/or memory resources to identify the key person associated with the entity requesting the transaction. For example, the creation and analysis of the graph based on data collected from multiple network nodes provides a computationally efficient method of identifying the key person by analyzing the links between vertices of the graph storing the metadata obtained from different network sources. For example, in comparison to other methods, such as brute force methods that consider a large number of combinations and/or permutations of the data (which may require long running times, and/or significant processing and/or memory resources), and/or manual methods that require significant effort from users to sort through the data.

The systems and/or methods described herein improve performance of the network connecting the consumer node with the web server hosting the web site, for example, by reducing network traffic, for example, by reducing the amount of data sent to the consumer node and/or other data packets sent to query the identification of the key person.

The systems and/or methods described herein may generate new data that includes the graph depicting connections between metadata obtained from multiple network sources. The analysis of the graph improves the computational efficiency of identifying the key person associated with the entity requesting the transaction, and/or the computational efficiency of cleaning the data (e.g., resolving conflicts, correcting errors, and filling in missing information).

The systems and/or methods described herein provide a unique, particular, and advanced technique of collecting and analyzing data dynamically from multiple network nodes to generate an offer to a key person(s) of an entity requesting a transaction at a website according to a transaction requirement.

Accordingly, the systems and/or methods described herein are inextricably tied to a network environment and/or to computer technology, to overcome an actual technical problem arising in network connected computing devices.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the phrases adaptive credit standing and dynamic transaction standing are sometimes interchanged.

As used herein, the phrases credit standing threshold and transaction requirement are sometimes interchanged.

As used herein, the terms customer node (or node) and client terminal are sometimes interchanged.

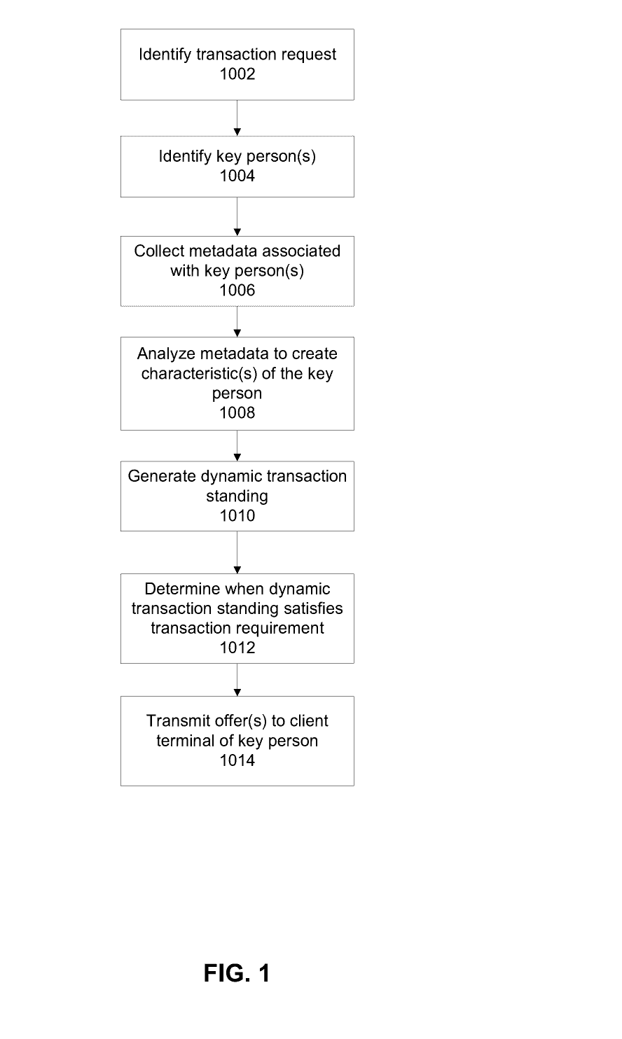

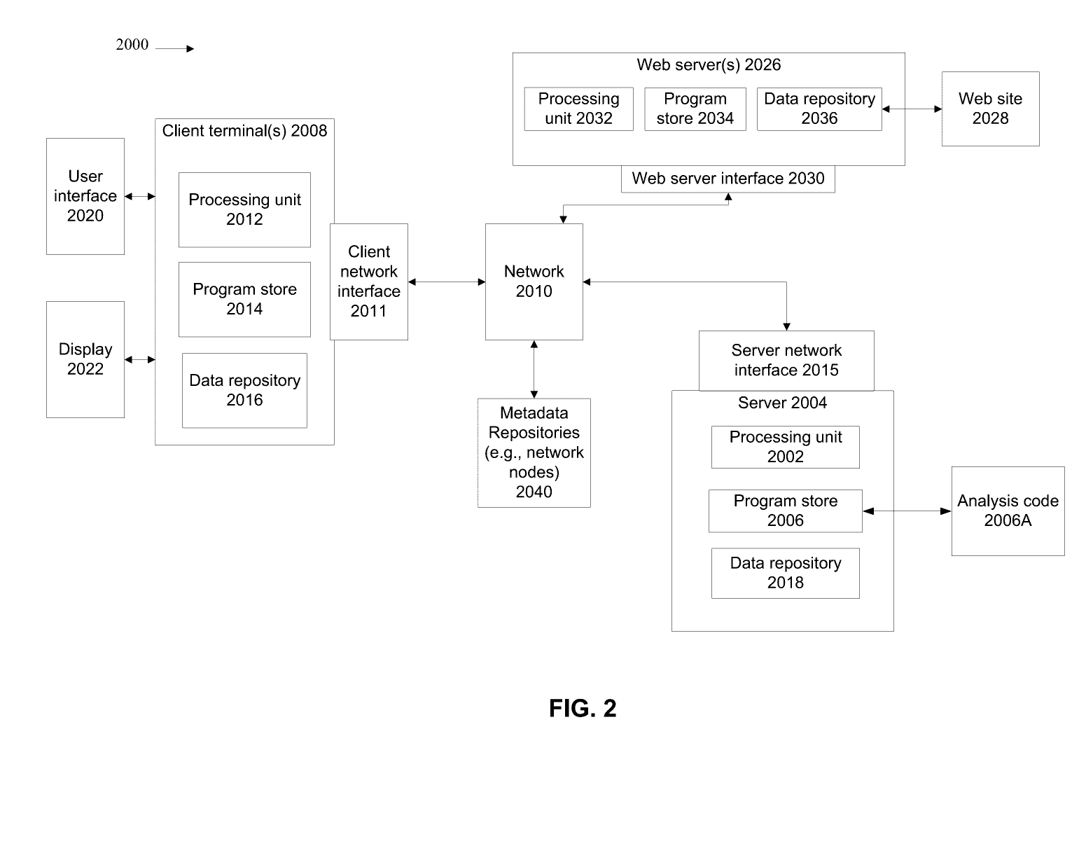

Reference is now made to FIG. 1, which is a flowchart of a method for analyzing data collected from network nodes, to identify one or more key person(s) associated with an entity requesting a transaction at a web server, and/or to analyze metadata collected from multiple network sources to generate an offer to the key person to assist with the transaction request, in accordance with some embodiments of the present invention. Reference is also made to FIG. 2, which is a block diagram of a system 2000 that analyses metadata collected from network sources to generate an offer to an identified key person to assist with a transaction request at a web server, in accordance with some embodiments of the present invention. System 2000 may implement the acts of the method of FIG. 1, for example, by processing unit 2002 of server 2004 executing code instructions (optionally, analysis code 2006A) stored in a program store 2006. It is noted that in another implementation, one or more functions performed by server 2004 may be stored in data repository 2016 for execution by processing unit 2012 of client terminal 2008, for example, as a user application.

Users browsing e-commerce websites may hesitate to make a purchase due to a lack of sufficient funds or available financing. This hesitation may result in lost revenue for merchants. Merchants may offer payments through already validated means, such as credit cards. The payment offers are the same to all customers regardless if the customer holds or does not hold a credit card. That is, merchants cannot offer financing options tailored to a specific customer. Further, such offers cannot be made as the customer browses an e-commerce website. The systems and/or methods described herein overcome the limitations of prior systems and methods by providing a computationally efficient mechanism for merchants to offer financing options specifically tailored to customers currently browsing their e-commerce websites.

System 2000 includes server 2004 which may be implemented, for example, as a central server, a computing cloud, a network server, a web server, as a stand-alone unit, as code installed on an existing computer, as a hardware card inserted into an existing computer, or other implementations. Server 2004 may be implemented as a hardware component (e.g., standalone computing unit), as a software component (e.g., implemented within an existing computing unit), and/or as a hardware component inserted into an existing computing unit (e.g., plug-in card, attachable unit). Server 2004 may provide services to client terminals 2008 by providing software as a service (SAAS), providing an application that may be installed on client terminal 2008 that communicates with server 2004, and/or providing functions using remote access sessions (e.g., web server accessed by a web browser installed on client terminal 2008).

Server 2004 is in communication with multiple client terminals 2008 over a network 2010 (using respective client network interface 2011 and server network interface 2015), for example, the internet, a private network, a local area network, and/or a cellular network, using wireless and/or wired connections. Interfaces 2011, 2030, and 2015 may include, for example, physical and/or virtual network connections, for example, network interface card(s), antennas, and/or interface applications.

Exemplary client terminals 2008 include, a mobile device, a desktop computer, a thin client, a Smartphone, a Tablet computer, a laptop computer, a server, a web server, a wearable computer, glasses computer, and a watch computer.

Client terminal 2008 includes a processing unit 2012 and a program store 2014 storing code instructions for execution by processing unit 2012.

Processing units 2002, and/or 2012 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processing unit(s) 2002, and/or 2012 may include one or more processors (homogenous or heterogeneous), which may be arranged for parallel processing, as clusters and/or as one or more multi core processing units, for example, distributed across multiple virtual and/or physical servers, for example, located within a computing cloud and/or at multiple network connected processing nodes.

Program stores 2006, and/or 2014 store code instructions implementable by respective processing units 2002, and/or 2012, for example, a random access memory (RAM), read-only memory (ROM), and/or a storage device, for example, non-volatile memory, magnetic media, semiconductor memory devices, hard drive, removable storage, and optical media (e.g., DVD, CD-ROM).

Client terminal(s) 2008, and/or server(s) 2004, may include respective data repositories 2016 and 2018 (e.g., memory, hard drive, optical disc, storage device, remote storage server, cloud server). Data repository 2016 of client terminal 2008 may store a GUI application and/or web browser for accessing server 2004.

Client terminal 2008 includes or is in communication with a user interface 2020 (which may be integrated with a display 2022, or be implemented as a separate device), for example, a touchscreen, a keyboard, a mouse, and voice activated software using speakers and microphone.

A web server (or other server) 226 hosts a website 228 for example, an online store, a social forum, online forms, and/or other stored web pages (or other application such as a social network).

Web server 2026 communicates with server 2004 and client terminal(s) 2008 over network 2010 using web server interface 2030. Web server 2026 includes processing unit 2032, program store 2034, and includes or is in communication with a data repository 2036. Processing unit 2032, program store 2034, and data repository 2036 may be implemented, for example, as described with reference to server 2004.

The acts of the method of FIG. 1 are described with reference to a certain client terminal 2008. It is understood that multiple client terminals 2008 may access server 2004. The description with reference to one of the client terminals 2008 is for clarity and simplicity, and is not meant to be limited to the described client terminal 2008.

Metadata repositories 2040 storing metadata that is analyzed to identify the key person and/or determine characteristics of the key person are in communication with server 2004 over network 2010. Exemplary metadata repositories include: public databases, private databases, news sites, blog sites, social network sites, and web servers.

The acts of the method of FIG. 1 are described with reference to server 2004 indirectly accessed by client terminal 2008 via web server 2026. It is understood that other implementations may used, for example, user of client terminal 2008 directly accessing server 2004 (e.g., using a web browser), user of client terminal 2008 running a locally stored intermediate tool (e.g., a script, an application programming interface (API), a software development kit (SDK) which accesses server 2004, and/or web server 2026 accessing serer 2004 (e.g., using the script, API, or SDK).

At 1002, a transaction request is identified. The transaction request may be triggered, for example, at website 2028 hosted by web server 2026, by an agent of the merchant using a client terminal in communication with web server 2026 over network 2010, automatically by code (e.g., API, SDK), and/or manually (e.g., by a worker of the merchant). The transaction requested may be triggered by an entity associated with a consumer node (i.e., client terminal 2008) accessing web site 2028.

The transaction request may be identified with a financial transaction, or a non-financial transaction.

For example, the transaction request may include a financial purchase transaction to purchase product(s) and/or service(s) from the website by a business entity. For example, the business entity is a physical store purchasing a supply of stock from a manufacturer or distributor using the website. The key person is, for example, the owner or manager of the physical store. The dynamic transaction standing (as described below) may include a dynamic credit standing indicative of the current credit rating of the key person. The transaction requirement defines a credit standing requirement (e.g., threshold, range), which represents the minimum dynamic transaction standing for completing the transaction. The offer includes a financial offer to provide financing (e.g., lending of money, providing goods on credit) to complete the financial purchase transaction.

Alternatively, in another example, the transaction request is based on a non-financial transaction. For example, the transaction request is based on a request to access the website by the entity, such as a forum dedicated only to certain users, or request to host a protest in a city, or request a permit. The entity may be a non-business entity, for example, non-profit organization, environmental organization, charity, government, public organization, academic organization. The dynamic transaction standing may include, for example, a dynamic public perception standing indicative of the perception of the public on the entity, for example, whether the public agrees with the operations of the entity, whether the public sees the activities of the organization favorably. The transaction threshold may include a public perception requirement (e.g., threshold, range) defining the minimum level of acceptable dynamic transaction standing. The offer may include, for example, an offer to help to improve public perception.

At 1004, one or more key person(s) associated with the entity are automatically identified by the analysis code executing on the server. The key person is based on the responsibility and/or control of the key person within the entity, for example, the owner of the entity, and/or high level manager of the entity. The key person represents an ability to make decisions for the entity.

The key person may be identified automatically based on a generated graph. The graph may be generated based on the metadata collected from each of multiple network nodes representing metadata repositories 2040, for example, news sites, social network sites, blogs, annual reports, review sites, forums, and product review sites.

Metadata repository 2040 may be stored by (or in association with) web server 2026 (e.g., the merchant may store the data of the clients that use the web site). Metadata may include, for example, home address, work address, company name, users, employees, phone numbers (e.g., home, mobile, work), email (e.g., private, work), employment position.

As discussed herein, the metadata may be missing details, and/or inaccurate, and/or duplicated, for example, nicknames may be used (e.g., Bob instead of Robert), or the address may be broad (e.g., only city without street and house number), and/or include errors (e.g., typographical error in the spelling of the company name). The metadata may be cleaned and/or fixed, as described herein.

The graph may be generated based on vertices storing metadata obtained from different repositories, and edges (single-directional or bi-directional) denoting connections between the data of the vertices. The connections denote similarity and/or relationships between instances of the metadata, for example, addresses may be linked, employees may be linked, and phone numbers may be linked.

The connections and/or data instances may be assigned weights, optionally based on an analysis, for example, employees with many connections to other employees may be assigned higher weights, indicating that employees with more connections are more significant than employees with less connections, and more likely to represent the key person of the entity.

The graph is analyzed to identify the key person of the entity. For example, graph analysis methods may be used to identify the key person based on paths through the graph having the highest weight and/or largest number of connections. For example, the CEO of the company is assumed to have the most connections and/or the highest weight in the organization.

In an example, metadata provided by the web server hosting the web site (or other data storage device associated with the operator and/or merchant of the web site) includes user name, email, company name (with typo), and home addresses that includes only the city. Multiple results may be obtained based on the metadata alone. When the graph is formed and analyzed (using other metadata sources), a company name that is similar (but not identical) to the company name with typo (from the web server) is identified. A user associated with the company name is identified as having an email address having the same domain as the provided login credentials. The user is identified as the key person. The company name is corrected.

Optionally, weights are assigned to each connection according to the type and/or accuracy of overlapping fields. For example, when the phone number of a certain person appears in a large number of different repositories, the person associated with the phone number is assumed to be key person, based on the assumption that the key person is well known and is contacted by many people.

Optionally, the graph is analyzed to identify duplicate data. The duplicate data is assumed to be associated with a higher probability of accuracy relative to non-duplicated data. The duplicate data is assigned a relatively higher weight to identify the key person relative to non-duplicate data. For example, when an address of the key person appears multiple times sometimes with variation, the value of the address that appears the most is assumed to be the correct address.

Optionally, the graph is analyzed to resolve inconsistencies in the data. For example, when two home addresses are found for the same person, each address is associated with a date, to determine the latest address as the correct address (based on the assumption that the older address represents a relocation.

Optionally, the graph is analyzed to correct errors in the data. For example, when two birthdates are identified, with one birthday appearing in 6 locations, and another birthday appearing in one location, the 6 location birthday is assumed to be correct.

Optionally, the graph is analyzed to complete missing details in the data. For example, when multiple mailing addresses are found, the data may be combined to generate a complete mailing address. For example, at one location, the postal code is missing, at another location, the city is missing, and at another location, only the P.O. Box is provided. The combination provides the address with P.O. Box, city, and postal code.

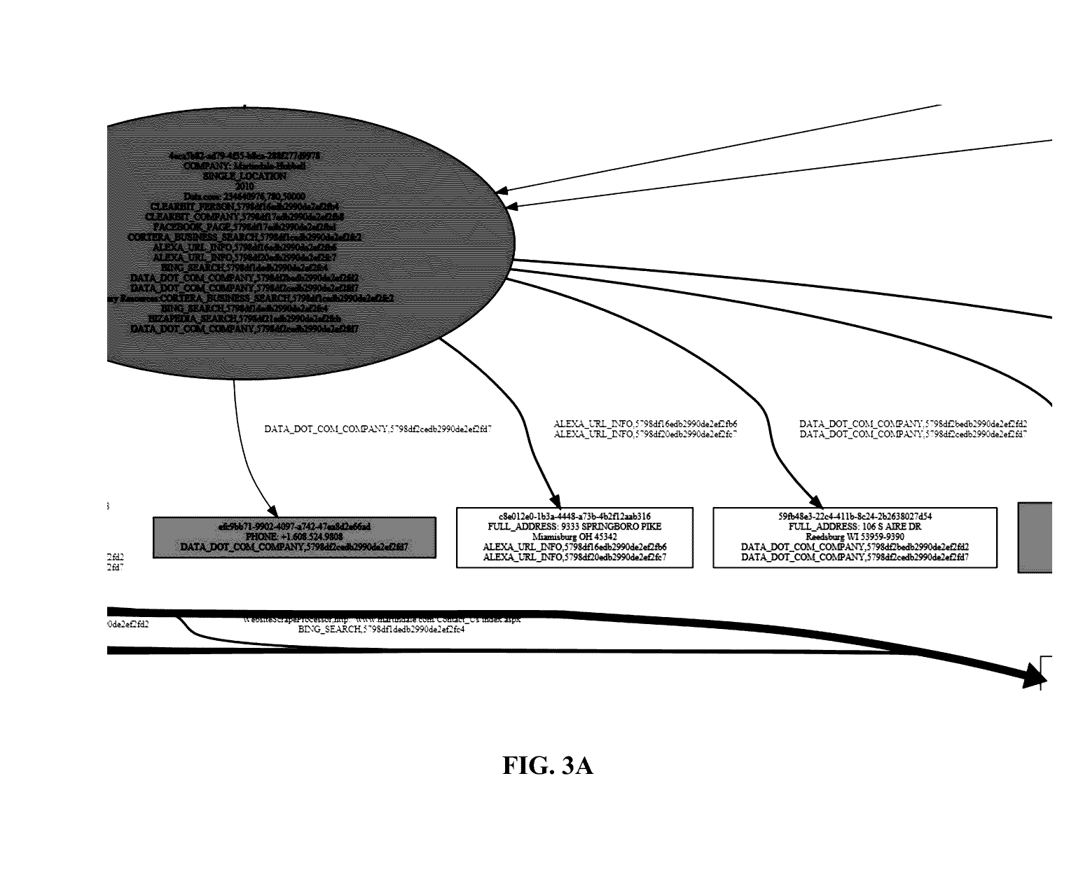

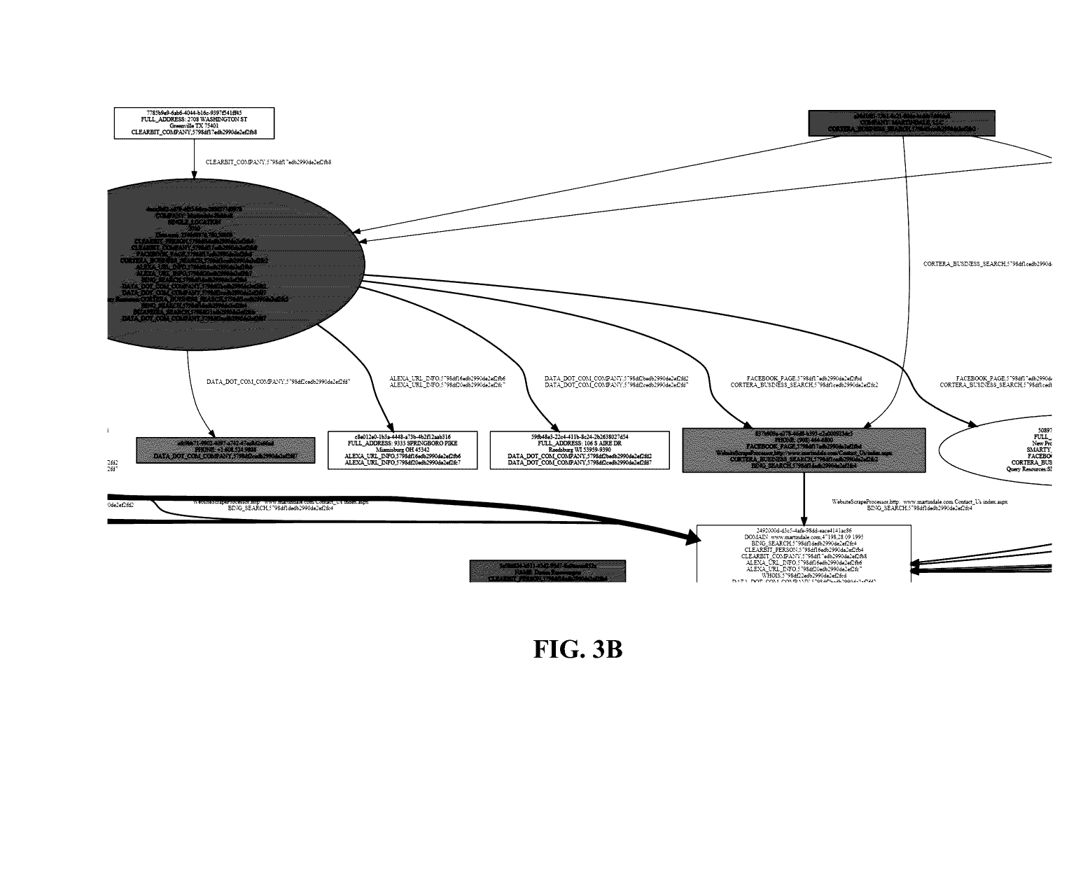

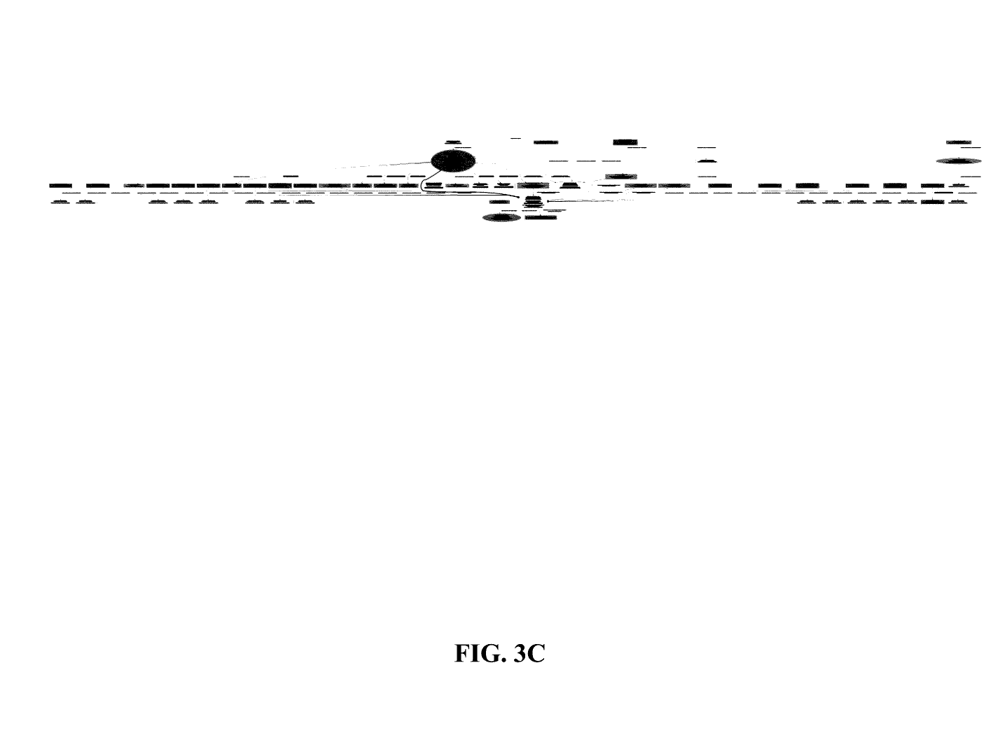

Reference is now made to FIGS. 3A-C, which include an example of a graph that includes connections between metadata sources, in accordance with some embodiments of the present invention. The graph may be analyzed to identify the key person associated with the entity requesting the transaction, as described herein. For clarity, the graph is shown at various levels of detail. FIG. 3A is a zoom-in of the graph, FIG. 3B is a middle zoom of the graph, and FIG. 3C depicts the entire graph.

Referring now back to FIG. 1, at 1006, metadata associated with the key person is collected from metadata repositories 2040, which may be the same, overlapping, or different than repositories 2040 accessed in block 1004.

The metadata may be collected by crawling code that follows links on web sites to crawl the network (e.g., the internet). For example, data from websites posting data about the key person is automatically collected by the crawling code. Links on the websites are followed by the crawling code to reach other sites that may store data about the key person.

The crawling program may reach, for example, social network sites, blog sites, review sites, and news sites.

Alternatively or additionally, the collected is performed by tracking activity of users of the entity accessing websites using the customer node, for example, sites visited by employees of the organization.

At 1008, the metadata is analyzed to create one or more characteristics of the key person. The characteristics may include customized definitions, and/or definitions according to a standard. The characteristics may be quantitative or qualitative. The characteristics may include, for example, legal integrity of the key person (e.g., criminal history of the key person, paid fines, legal battles), financial integrity of the key person (e.g., history of paying on time), honesty (e.g., history of lawsuits, good reviews), and the like.

At 1010, a dynamic transaction standing is generated based on the characteristics. The dynamic transaction standing may be generated, for example, as a set of characteristics, a value calculated by a weighted average of the characteristics, a normalized value, or other computational methods. For example, the dynamic transaction standing may be a normalized value between 0 and 100, where 0 denotes no chance of obtaining financial credit, and 100 denotes obtaining any amount of financial credit.

The transaction standing is dynamically generated based on the current metadata used to generate the characteristics. The dynamic transaction standing represent the current (e.g., near real-time, updated) status of the key person in terms of risk of paying back the provided credit.

It is noted that the dynamic transaction standing may be defined for non-financial transactions. For example, in terms of public perception, 0 denotes a poor public perception by all, and 100 denotes an excellent public perception by all.

At 1012, the analysis code of the server determines whether the dynamic transaction standing satisfies a transaction requirement (e.g., threshold, range) associated with the transaction request. The transaction requirement represents the minimum requirement for the dynamic transaction standing.

For example, when the transaction requirement is a threshold of value 70 (on the described 0-100 scale), the key person is provided credit when the dynamic transaction standing is over 70, and denied credit when below 70.

The transaction requirement may be dynamically computed according to the current transaction, and/or predefined (e.g., as a system setting). For example, the transaction requirement may be computed using code according to the cost of the transaction (e.g., a larger purchase being associated with a larger transaction requirement). In another example, the transaction requirement may be manually defined by the owner of the web site, for example, the owner might not want to take risks, and set a high transaction requirement, even for modest sums of money.

For example, for relatively low sums of money, the transaction requirement threshold may be 30 (on the described 0-100 scale), the transaction requirement threshold may be 50 for moderate sums, and the transaction requirement threshold may be 80 for high sums. For a key person having the computed dynamic transaction standing value of 60, small and moderate sums of money are lent, but high sums are denied.

At 1014, the server transmits one or more offers to a client terminal associated with the key person (which might be different than the client terminal used by a user representing the entity performing the transaction). The offer(s) is transmitted when the dynamic transaction standing satisfies the transaction requirement, for example the value of the dynamic transaction standing is above the transaction threshold. The offer may be provided manually, for example, by an employee of the web site calling the key person using a phone to present the offer.

The offer may include an offer to provide credit to the key person to purchase the product and/or service, and/or lend money to the key person for purchasing the product and/or service.

The offer may be provided when the entity is unable to purchase the product and/or service using available financial means, for example, using a credit card or bank transfer, or other immediately available financing sources. Alternatively, the offer may be provided to each key person, regardless of the state of the user representing the entity.

The offer may be presented on the graphical user interface (GUI) presented on a display of the client terminal of the user.

The offer may be calculated according to the difference between the dynamic transaction standing and the transaction threshold associated with the transaction request. The difference is indicative of the amount of financial credit required to complete the transaction.

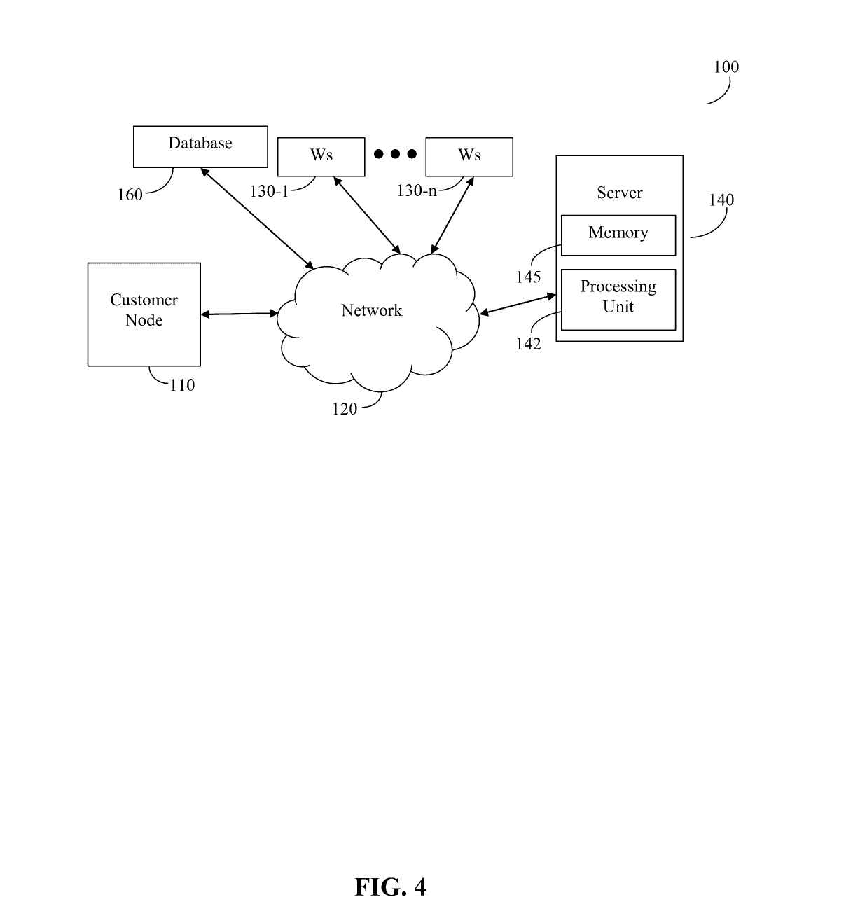

An aspect of some embodiments of the present invention relates to a method and/or system for proactively offering financing offers to business entities is provided. The method includes identifying that a user associated with the business entity logs on to a website; identifying at least one key person associated with business entity upon determination that the business entity credit is not sufficient; collecting data related to the at least one key person; generating at least one characteristic of the at least one key person based on the collected data; computing an adaptive credit standing of the business entity based on the at least one characteristic; determining whether the adaptive credit standing meets a credit standing threshold associated with at least one product of interest; and upon determining that the adaptive credit standing meets the credit standing threshold, providing at least one financing offer to the customer node. Reference is now made to FIG. 4, which shows an exemplary and non-limiting schematic diagram of a system 100 for enabling web-based purchase order financing, in accordance with some embodiments of the present invention. System 100 may be implemented based on, and/or corresponding to, and/or in association with, system 2000 described with reference to FIG. 2. Accordingly, a customer node 110 is connected to a network 120. The customer node 110 may be, but is not limited to, a personal computer (PC), a laptop computer, a mobile device, and the like. The network 120 may be a wired network or a wireless network, a local area network (LAN), a wide area network (WAN), a metro area network (MAN), the Internet, the worldwide web (WWW), and any combinations thereof. The customer node 110 is associated with a business entity and operated by one or more users associated therewith. A business entity is, for example, an entity formed and administered as per commercial law in order to engage in business activities, charitable work, or other activities allowable. In current disclosure, the business entity is sometimes defined as a commercial entity in need to acquire a product or a service.

The customer node 110 may communicate with one or more web-sources 130-1 through 130-n (hereinafter sometimes referred to collectively as web-sources 130 or individually as a web-source 130, merely for simplicity), where n is an integer equal to ‘1’ or greater. The web-sources 130 may be, for example, electronic commerce (e-commerce) websites, travel websites, services websites, and other web-sources through which a customer is able to purchase goods or services via the customer node 110. For the sake of simplicity and without necessarily limiting the disclosed embodiments, goods and/or services may be collectively referred to as “products” or a “product”.

In some implementations, the system 100 may further include a server 140 and a database 160 connected to the network 120. The database 160 stores, for example, characteristics associated with the key person and/or respective business entities, metadata related to purchase orders, customer black lists, and the like.

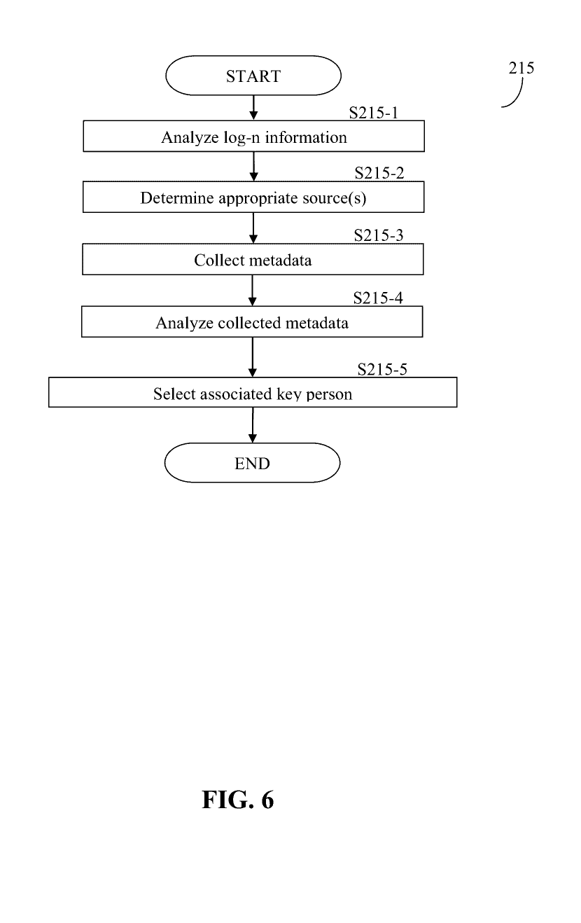

The server 140 is communicatively connected to the web-sources 130 via a connection to the network 120. In some implementations, the server 140 identifies a logon of a customer node associated with a business entity to a web source, for example, the web-source 130. It should be noted that a log on to a web source may include, for example, browsing through a website hosted by the web source 130-1, providing user's credentials to authenticate or sign-in to a website hosted by the web source 130-1, and the like. In some exemplary embodiments, upon logon to web source 130-1, a script (or any type of executable code, e.g., API, SDK) may be downloaded to the customer node 110 allowing collection of data and communication with the server 140. The server 140 then checks whether a sufficient credit standing was previously determined for the business entity associated with the customer node 110. When not, the key person associated with the business entity is identified by the server 140. The key person is, for example, an executive that is identified as an authorized officer of the company. The identification of the key person is further described herein, for example, below with respect of FIG. 6. Metadata respective of the key person is collected. As a not necessarily limiting example, the collection may include crawling through one or more social networks over the network 120 and identifying data related to the key person. According to another implementation, the collection may include crawling through one or more public databases over the network 120 that may include financial, legal and/or educational data associated with the key person.

Using the collected data, characteristics related to the key person associated with the business entity are generated. Characteristics may include type(s) of input captured with respect to the history of the key person. The characteristics may further include commercial and/or legal information related to the key person, and/or information demonstrating how the key person has previously interacted with the web-source 130-1. The information related to the key person may include, but is not necessarily limited to, the email address associated with the key person, the source from which the customer node 110 accessed a web-source 130, the geographic location of the business entity, and the like. In some implementations, using the characteristics, the server 140 generates an adaptive credit standing of the business entity.

Optionally, each of the characteristics is analyzed by the server 140 during the generation of the adaptive credit standing. The analysis may be based on hierarchical threshold-based stages. At the first stage, it may be determined whether the business entity has a sufficient credit standing predetermined by the server 140 that exists in the database 160 for buying products through the web source.

The adaptive credit standing threshold may be used to determine whether the business entity passes the minimal requirements for extending any credit. Additional credit and/or other favorable terms may be granted when the business entity passes the adaptive credit standing threshold by a predetermined level. Optionally, as part of the analysis, a virtual value is generated for each element of the one or more characteristics.

Optionally, a weighted decision algorithm is utilized to compute the adaptive credit standing. Accordingly, each characteristic collected is assigned a virtual value indicating the importance of the respective characteristic to the adaptive credit standing. Optionally, the weighted decision algorithm computes the credit standing, for example, as an average of a sum of the virtual values. The computation of virtual values may be adjusted based on the total amount of data collected. For example, when only a few elements are collected, each such collected element is considered as more significant in the credit determination. As another example, data collected from a credit bureau indicating the business entity's financial status may receive a higher virtual value than the key person's comments in a social network website and therefore is more significant in the determination of the credit.

Respective of the interest in the purchase order, the server 140 generates metadata related to the purchase order. The metadata may be, for example, the product or service to be ordered, costs associated with the order, and the like. The server 140 generates a credit standing threshold to finance the purchase order. The credit standing threshold is generated respective of the metadata. For example, purchase orders featuring higher cost items will typically yield higher credit standing thresholds.

Upon determination that the credit standing of the business entity meets the credit standing threshold, a financing offer is provided to the customer node 110. The financing offer may be embedded in a content item displayed on a display of the customer node 110. Such a content item may represent, for example, an offer to finance the purchase order, a link through which the purchase order may be financed, a guarantee to finance the purchase order, details regarding the credit line, and the like.

Alternatively or additionally, upon determination that the credit standing of the business entity meets the credit standing threshold above a predetermined level, a notification is sent to the customer node 110 for presentation on the display. The notification may state, for example, that there is additional credit that the customer may use, that additional purchase orders may be financed, and the like.

Optionally, upon determination that the credit standing of the business entity associated with the customer node 110 does not meet the credit standing threshold, operation of the system 100 terminates. Alternatively, upon determination that the credit standing does not meet the credit standing threshold, a notification that the customer's credit is insufficient is sent to the customer node 110.

It should be noted that, optionally, the financing offers are made proactively, typically without requiring the business entity to request such offers. Thus, the systems and/or methods described herein incentivize the business entity to buy products on a merchant's web source 130. It should be further noted that the operation of the system 100 as described herein may be executed automatically and without the customer's explicit involvement, thereby enabling merchants to interact with the customer only upon determination that the customer has a credit standing that meets the credit standing threshold to finance the purchase order.

Such automatic execution reduces consumption of computing resources by minimizing data transferred between the customer node 110 and the web source 130-1. For example, customers that do not pass the minimal thresholds set by the owner of the web-source 130 may be automatically filtered out such that only serious potential customers are fully analyzed. Further, full analysis of serious potential customers does not require significant communications between the customer node 110 and the web-source 130 because data related to such customers may be collected and analyzed in real-time.

In some implementations, the server 140 typically includes a processing unit 142 connected to a memory 145. The memory 145 contains a plurality of instructions that are executed by the processing system. Specifically, the memory 145 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The processing unit 142 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The memory 145 further contains instructions that, when executed by the processing unit 142, configures the server 140 to implement the systems and/or methods described herein.

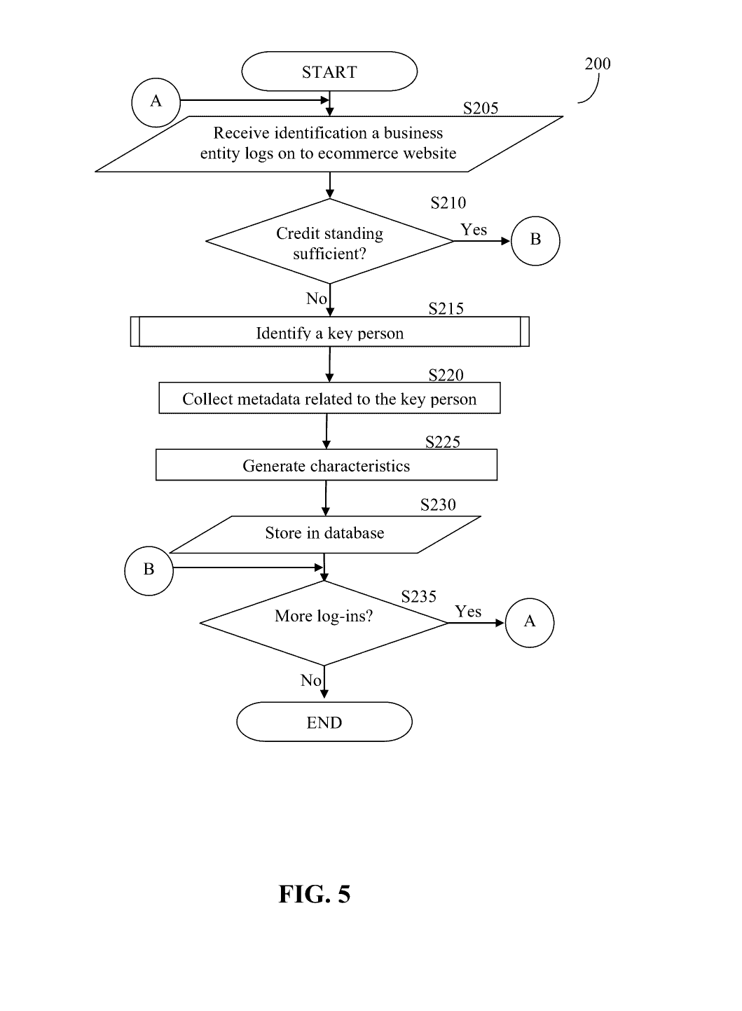

Reference is now made to FIG. 5, which depicts an exemplary and not necessarily limiting flowchart 200 illustrating a method for proactively offering financing offers to business entities, in accordance with some embodiments of the present invention.

In S205, an identification that a business entity logs on to a website is received and acknowledged. Optionally, such identification may be received from a script downloaded to the customer node when the business entity browses the website.

In S210, it is checked whether a sufficient credit standing was previously determined for the business entity and if so, execution continues with S235; otherwise, execution continues with S215.

In S215, a key person associated with the business entity is identified. The identification of the key person is further described herein below with respect of FIG. 6. Alternatively or additionally, the identification of the key person is performed based on the method described with reference to FIG. 1, and/or the system described with reference to FIG. 2.

In S220, metadata related to the key person is collected from a plurality of web source 130. Optionally, the metadata may be collected implicitly by tracking the key person activity or by capturing and analyzing inputs from one or more sensors of a customer node (e.g., the customer node 110) associated with the key person such as, for example, a camera, a voice recorder, and the like. Optionally, the data may be collected explicitly from the key person's responses to questions. Such data may be, for example, a variety of characteristics related to the customer determined via a customer node.

In S225, one or more characteristics related to the key person are generated using the collected metadata. Characteristics may be, for example, facial or voice reactions, mouse scrolling and/or keyboard typing, personal information related to the key person, and information demonstrating how the key person has previously interacted with a web-source, and the like.

In optional S230, the generated characteristic(s) are stored in a database, for example, the database 160. The characteristics may be provided for analyzing business entities, research, etc.

In S235, it is checked whether there are additional log-ins and if so, execution continues with S205; otherwise, execution terminates.

Reference is now made to FIG. 6, which depicts an exemplary and non-limiting flowchart 215 illustrating a method for identifying a key person associated with a business entity, in accordance with some embodiments of the present invention.

In S215-1, the log-on information is analyzed by the server 140. It should be noted that a logon to a web source may include, for example, browsing through a website hosted by the web source 130-1, providing user's credentials to authenticate or sign-in to a website hosted by the web source 130-1, and the like. Optionally, upon logon to a web source 130-1, a script (or any type of executable code) may be downloaded to the customer node 110 allowing collection of data and communication with the server 140.

In S215-2, respective of the collected data, appropriate resources over the web from which metadata indicative of a key person associated with the business entity are identified. As a non-limiting example, a location from which the log-on performed maybe indicative of certain databases exist over the network 120 which include therein legal and/or commercial data related to that location. As another example, a domain name appears in an email address with which the log-on was performed is identified. The domain may include data regarding one or more key persons associated with the business entity.

In S215-3, metadata indicative of a key person associated with the business entity is collected from the appropriate source(s).

In S215-4, the collected metadata is analyzed by the server 140 and in S215-5, respective of the analysis, a key person associated with the business entity is selected.

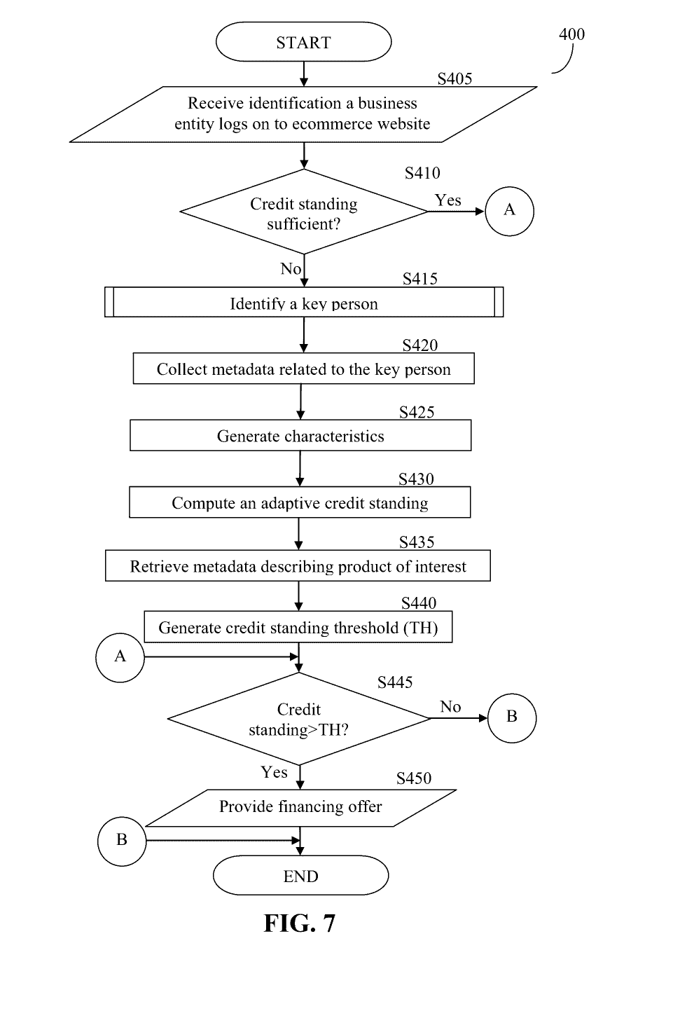

Reference is now made to FIG. 7, which depicts an exemplary and not necessarily limiting flowchart 400 illustrating a method for proactively offering financing offers to business entities, in accordance with some embodiments of the present invention.

In S405, an identification that a business entity logs on to a website is received and acknowledged.

In S410, it is checked whether a sufficient credit standing was previously determined for the business entity and if so, execution continues with S445; otherwise, execution continues with S415.

In S415, a key person associated with the business entity is identified.

In S420, metadata related to the key person is collected from a plurality of web source 130.

In S425, one or more characteristics related to the key person are generated using the collected metadata.

In S430, an adaptive credit standing is generated for the business entity using the generated characteristics. Optionally, a weighted decision algorithm is utilized to compute the adaptive credit standing. Accordingly, each characteristic is assigned with a virtual value indicating the importance of the respective parameter to the credit standing. Optionally, the weighted decision algorithm computes the adaptive credit standing, for example as an average sum of the virtual values. According to further embodiment, certain factors may be considered in order to optimize the determination of the adaptive credit standing. Such factors may include, for example, a time lapse for the determination of the adaptive credit standing, costs associated with the determination, a combination thereof and more. As an example, data used for the determination may be retrieved from data sources and/or portions of a database, and in case the costs associated with retrieving data from a first source is significantly lower than the costs associated with retrieving data from a second source, the server 130 may retrieve the data from the first data source. It should be noted that in complicated cases, for example, cases where the adaptive credit may adjust significantly depending on different factors, more data sources may be queried than in less complicated cases.

In S435, metadata describing the product in interest is retrieved, for example, from the database 160. The metadata may include, for example, the product or product category in interest, their costs associated, shipping information, available quantity, and the like.

In S440, a credit standing threshold (TH) is generated respective of the metadata. The credit standing threshold indicates a requirement for determining if a business entity passes the minimal requirements for extending any credit.

In S445, it is checked whether the adaptive credit standing of the customer meets the credit standing threshold and, if so, execution continues with S250; otherwise, execution ends.

In S450, at least one financing offer is provided to the customer node 110. The provided offer may be determined based on the value of the adaptive credit standing versus the credit standing threshold. Optionally, each of the at least one financing offer is embedded in a content item displayed on a display of the customer node 110. Optionally, a notification may be displayed to the customer that there are no available financing offers when the customer's adaptive credit standing does not meet the threshold.

An aspect of some embodiments of the present invention relate to a method for proactively offering financing offers to business entities, comprising: identifying that a business entity logs on to a website by a customer node; upon determination that no sufficient credit standing is identified for the business entity, identifying at least one key person associated with the business entity; collecting metadata related to the at least one key person associated with the business entity; and, generating at least one characteristic of the at least one key person based on the collected data.

Optionally, the method further comprises computing an adaptive credit standing of the business entity based on the at least one characteristic; determining whether the adaptive credit standing meets a credit standing threshold associated with at least one product of interest; and upon determining that the adaptive credit standing meets the credit standing threshold, providing at least one financing offer to the customer node.

Optionally, the method further comprises determining a target interest of the business entity in the at least one product; and computing the adaptive credit standing only when the determined target interest meets a predefined interest threshold.

Optionally, determining the target interest meets a predefined interest threshold further comprises: retrieving metadata respective of the least one product; and generating, based on the metadata, the credit standing threshold for financing the purchase.

Optionally, the at least one product is any one of: goods, a service, and a product category.

Optionally, the at least one financing offer is embedded in a content item displayed on the customer node.

Optionally, the identification of the key person comprising: determining one or more appropriate resources for metadata indicative of a key person associated with the business entity; collecting the metadata from the one or more appropriate resources; and, analyzing the metadata.

Optionally, collecting the data related to the key person further comprises: implicitly collecting data by at least one of: tracking customer activity and an analysis of inputs captured by at least one sensor of the customer node.

Optionally, collecting the data related to the key person further comprises: explicitly collecting data by requesting feedbacks from the customer.

Optionally, the determination of the appropriate resources is made respective of the log-on information.

Optionally, the method further comprises assigning a virtual value to each of the at least one customer characteristic, wherein the virtual value indicates the importance of the respective customer characteristic to the adaptive credit standing; and computing a weighted sum average of the assigned virtual values to result in the adaptive credit standing.

Optionally, the virtual values are adjusted based on a total amount of data collected.

Optionally, a non-transitory computer readable medium having stored thereon instructions for causing one or more processing units to execute the method.

An aspect of some embodiments of the present invention relate to a system for proactively offering financing offers to business entities, comprising: a processing unit; and a memory, the memory containing instructions that, when executed by the processing unit, configure the system to: identifying a log on of a business entity to a website by a customer node, collect data related to the business entity; upon determination that the business entity credit do not cross a credit threshold, identifying at least one key person associated with the business entity; collecting metadata related to the at least one key person associated with the business entity; and, generate at least one characteristic of the at least one key person based on the collected data.

Optionally, the system is further configured to: compute an adaptive credit standing of the business entity based on the at least one characteristic; determine whether the adaptive credit standing meets a credit standing threshold associated with at least one product of interest; and, upon determining that the adaptive credit standing meets the credit standing threshold, provide at least one financing offer to the customer node.

Optionally, the system is further configured to determine a target interest of the business entity in the at least one product; and compute the adaptive credit standing only when the determined target interest meets a predefined interest threshold.

Optionally, determining the target interest meets a predefined interest threshold further comprises: retrieving metadata respective of the least one product; and generating, based on the metadata, the credit standing threshold for financing the purchase.

Optionally, the at least one product is any one of: goods, a service, and a product category.

Optionally, the at least one financing offer is embedded in a content item displayed on the customer node.

Optionally, the identification of the key person comprising: determining one or more appropriate resources for metadata indicative of a key person associated with the business entity; collecting the metadata from the one or more appropriate resources; and, analyzing the metadata.

Optionally, collecting the data related to the key person further comprises:

implicitly collecting data by at least one of: tracking customer activity and an analysis of inputs captured by at least one sensor of the customer node.

Optionally, collecting the data related to the key person further comprises: explicitly collecting data by requesting feedbacks from the customer.

Optionally, the determination of the appropriate resources is made respective of the log-on information.

Optionally, computing the adaptive credit standing further comprises: assigning a virtual value to each of the at least one customer characteristic, wherein the virtual value indicates the importance of the respective customer characteristic to the adaptive credit standing; and computing a weighted sum average of the assigned virtual values to result in the adaptive credit standing.

Optionally, the virtual values are adjusted based on a total amount of data collected.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant client terminals, web servers, web sites, and servers will be developed and the scope of the terms client terminal, web server, web site, and server are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method for analyzing data collected from a plurality of network nodes, the method executed by a server connected to at least one website and at least one consumer node, the method comprising:
identifying a transaction request at a website hosted by a web server, the transaction requested by an entity associated with a consumer node;
identifying at least one key person associated with the entity;
collecting, from a plurality of network nodes, metadata associated with the at least one key person;
analyzing the metadata to create at least one characteristic of the at least one key person;
generating a dynamic transaction standing based on the at least one characteristic;
determining whether the dynamic transaction standing satisfies a transaction requirement associated with the transaction request; and
transmitting, to a node associated with the at least one key person, at least one offer when the dynamic transaction standing satisfies the transaction requirement.

2. The method of claim 1, wherein the transaction request comprises a financial purchase transaction to purchase at least one product and/or service from the website by the entity, wherein the entity comprises a business entity, wherein the dynamic transaction standing comprises a dynamic credit standing, wherein the transaction requirement comprises a credit standing requirement, and wherein the at least one offer comprises at least one financial offer to provide financing to complete the financial purchase transaction.

3. The method of claim 1, wherein the transaction request comprises a request to access the website by the entity, wherein the entity comprises a non-profit and/or environmental and/or charity associated entity, wherein the dynamic transaction standing comprises a dynamic public perception standing indicative of the perception of the public on the entity, wherein the transaction requirement comprises a public perception requirement, and wherein the at least one offer comprises help to improve public perception to access the website.

4. The method of claim 1, wherein the at least one offer is calculated according to the difference between the dynamic transaction standing and the transaction requirement associated with the transaction request, wherein the difference is indicative of the amount of financial credit required to complete the transaction.

5. The method of claim 1, wherein the identifying at least one key person associated with the entity is automatically performed by the server, the identifying comprises:
generating a graph based on the metadata collected from each of the plurality of network nodes, wherein connections are defined between nodes of the graph each storing metadata collected from a respective network node, wherein the connections denote similarity and/or relationships between instances of the metadata; and
analyzing the graph to identify the at least one key person according to the entity.

6. The method of claim 5, wherein at least one weight is assigned to each connection according to the type and/or accuracy of overlapping fields.

7. The method of claim 5, further comprising analyzing the graph to identify duplicate data, wherein the duplicate data is associated with a higher probability of accuracy relative to non-duplicated data, wherein the duplicate data is assigned a relatively higher weight to identify the at least one key person relative to non-duplicate data.

8. The method of claim 5, further comprising analyzing the graph to resolve inconsistencies in the data.

9. The method of claim 5, further comprising analyzing the graph to correct errors in the data.

10. The method of claim 5, further comprising analyzing the graph to complete missing details in the data.

11. The method of claim 1, wherein the collecting, from the plurality of network nodes, metadata associated with the at least one key person, comprises collecting, using crawling software that crawls the network, data from websites posting data about the at least one key person.

12. The method of claim 11, wherein the websites are selected from the group consisting of: social network sites, blog sites, review sites, and news sites.

13. The method of claim 1, wherein the collecting is performed by tracking activity of users of the entity accessing websites using the customer node.

14. A system for analyzing data collected from a plurality of network nodes, comprise:
a server comprising:
a network interface that provides communication with at least one website hosted by at least one web server, at least one consumer node, and a plurality of network nodes storing data;
a program store storing code; and
at least one processor coupled to the network interface and the program store for implementing the stored code, the code comprising:
code to identify a transaction request at the transaction requested by an entity associated with a consumer node, identify at least one key person associated with the entity, collect from a plurality of network nodes, metadata associated with the at least one key person,
code to analyzing the metadata to create at least one characteristic of the at least one key person, generate a dynamic transaction standing based on the at least one characteristic, determine whether the dynamic transaction standing satisfies a transaction requirement associated with the transaction request; and
code to transmit, to a client terminal associated with the at least one key person, at least one offer when the dynamic transaction standing satisfies the transaction requirement.

15. A computer program product comprising a non-transitory computer readable storage medium storing program code thereon for implementation by at least one processor of a server connected to at least one website and at least one consumer node, for analyzing data collected from a plurality of network nodes, comprising:
instructions to identify a transaction request at a website hosted by a web server, the transaction requested by an entity associated with a consumer node;
instructions to identify at least one key person associated with the entity;
instructions to collect, from a plurality of network nodes, metadata associated with the at least one key person;
instructions to analyze the metadata to create at least one characteristic of the at least one key person;
instructions to generate a dynamic transaction standing based on the at least one characteristic;
instructions to determine whether the dynamic transaction standing satisfies a transaction requirement associated with the transaction request; and
instructions to transmit, to a node associated with the at least one key person, at least one offer when the dynamic transaction standing satisfies the transaction requirement.
